(19) United States
(12) Patent Application Publication
(10) Pub. No.: US 2017/0072591 A1
(43) Pub. Date: Mar. 16, 2017

(54) METHOD FOR MAKING A CEMENTITIOUS MORTAR BASED COMPOSITE PANEL WITH LIGHT TRANSLUCENCY PROPERTIES AND A STRUCTURE OF LIGHT TRANSLUCENT MATERIAL

(71) Applicant: ITALCEMENTI S.P.A., Bergamo (IT)

(72) Inventors: Aronne CARMINATI, Chignolo d'Isola (IT); Nicola RIZZO, Bergamo (IT)

(21) Appl. No.: 15/122,979

(22) PCT Filed: Mar. 4, 2015
(86) PCT No.: PCT/EP2015/054474

§ 371 Date: Sep. 1, 2016

(30) Foreign Application Priority Data
Mar. 4, 2014 (IT) MI2014A000324

(51) Int. Cl. B28B 23/00; E04C 2/04; E04C 2/54

(52) U.S. Cl. CPC B28B 23/0037; E04C 2/54; E04C 2/044

(57) ABSTRACT

The present invention relates to a method for making a cementitious mortar based composite panel comprising portions made of translucent material which are developed from a first side (1′) of the panel (1) to a second side (1″) opposite to the first side. The method includes making a monolithic structure (3) made of light translucent material provided with a base (10) and a plurality of elements (12,12′,12″) which develop from said base (10). The structure is made by means of a plastic injection molding process. The method includes arranging such a structure inside a formwork so as to arrange all the elements in the predetermined position for the subsequent step of pouring in a single operation. The method finally includes finishing off the cementitious mortar obtained following the hardening of the cementitious mortar, by eliminating said base (10) of said structure (3) and by defining said flat sides (1′,1″) of said panel (1).

### FIELD OF THE INVENTION

The present invention relates to the manufacturing of cementitious articles, in particular of cementitious mortar based composite panels with light translucency properties. In particular, the present invention relates to a new method for making a cementitious mortar based composite panel. The present invention also relates to a composite panel comprising such a structure and to a monolithic structure made of translucent material which can be used in the aforesaid method.

### PRIOR ART

The use of cementitious articles with light translucency properties is known. As known, a possible manufacturing process of such cementitious articles (e.g. described in patent application WO03097954) includes the use of optical fibers inside the articles which are then finished off into blocks or panels. However, such a technology has proven to be rather ineffective because the translucency effect, i.e. the transmission of light from one side of the panel to the other, is conditioned by the light intensity incident on the block and of its incidence angle. It has been seen that beyond a given value of such an angle, the translucency effect gradually decreases, this constituting an obvious limitation of such a technique. Other drawbacks related to this technology are found, for example, in the difficult positioning of the optical fibers in the block and the need for complicated steps of cutting and polishing to finish off the article. This obviously implies waste of material, particularly if large parts are required.

It is know that the limitations and problems related to the foregoing solution are overcome in part by using cementitious mortar based composite panels comprising portions of light translucent material, which are of the “through” type, i.e. extend through the entire thickness of the panel. With this regard, patent application EP 2376718 describes some embodiments of such composite materials in which the light translucent elements are made of polymethyl methacrylate (PMMA). In order to obtain such panels, the PMMA elements are positioned inside a formwork and arranged according to parallel lines by exploiting appropriate spacers which keep the elements reciprocally spaced apart from one another. The formwork is then filled with cementitious material to bury the PMMA elements without the opposite faces thereof coming into contact with the mortar. The cementitious mortar is thus hardened and the panel is extracted from the formwork.

With respect to the use of optical fibers, the PMMA elements are more effective because the translucency effect is reached in all cases, also in presence of unfavorable light angles. Furthermore, from the manufacturing point of view, the manufacturing of PMMA elements substantially does not cause any processing waste, i.e. waste of material. However, it has been observed that the methods for making panels with PMMA elements currently have huge drawbacks which require a solution in order to make this technology easily useable.

With this regard, again with reference to the solution described in EP 2376718, the PMMA elements appear as longitudinal elements characterized by portions having a height equal to the thickness (through portions) of the panel and connected to lower height portions according to a substantially “chain-like” development. It has been seen that there are two critical aspects in the cost formation of each “chain-like” element, the first of which is the cost of the material, and more specifically of the PMMA rectangle from which the “chain” is obtained. The second aspect relates to the cost of the cutting process used to configure such elements. Furthermore, the PMMA elements are made “to size”, i.e. as a function of the required size of the panels. This is a further criticality in terms of manufacturing costs.

A further drawback of “optical” nature has arisen in the use of the panels made with “chain-like” elements caused by the joint regions between the “through portions” and the lower height portion of the elements themselves. Indeed, such regions appear “dark”, or in all cases opaque, to an observer observing the panel according to a direction of observation different from that perpendicular to the panel itself. It is seen that this optical phenomenon is, in many cases, a deterrent to purchasing and in general to using the panels in general.

It has equally been found that the current production of panels is based on a substantially hand-crafted procedure, requiring a manual positioning of the single PMMA element (chains) in the formwork. Such a positioning requires care and diligence by the operators. At the same time, the pouring operations of the cementitious mortar in the formworks require particular care to limit possible misalignment of the PMMA elements as much as possible. Indeed, it has been found that in the manufacturing process described above, panels are often obtained in which the chains are arranged “irregularly” because parallelism is poor and straightness lacks. This firstly compromises the good appearance results of the panels themselves and thus the final quality of the product.

Thus, the need for manufacturing methods alternative to the current ones clearly arises to reduce manufacturing time and end costs, in particular, according to the conditions indicated above. At the same time, the need arises to have higher quality panels, the inner structure of which does not determine drawbacks of optical nature as that described above.

### SUMMARY

It is the main task of the present invention to provide a new method for making a cementitious mortar based composite panel with light translucency properties which allows to overcome the drawbacks of the prior art. In the scope of this task, it is a first object to provide a method which allows to simplify in considerable manner the steps of assembly which precede the pouring of the cementitious mortar. It is a further object of the present invention to make the manufacturing of panels more cost-effective avoiding processing and material waste as much as possible. A further object of the present invention is to provide high quality panels the inner structure of which does not originate drawbacks of optical nature. A not last object of the present invention is to provide a method which is reliable and easy to implement at competitive costs.

This task and these objects are reached by means of a manufacturing method as indicated in claim 1. Such a method is thus based on the use of a monolithic structure made of light translucent plastic material, which is preferably obtained by means of a plastic injection molding process. Such a structure comprises a base and elements which are developed therefrom according to a predetermined arrangement. The positioning of the monolithic structure within a formwork is advantageously obtained by means of a single operation at the end of which the plastic material elements assume the predetermined position for the pouring. With respect to the traditional methods, this translates into a considerable reduction of manufacturing costs.

According to a further aspect, the monolithic structure is modular to the advantage of higher versatility in terms of the possibility of obtaining panels of different sizes. Indeed, multiple monolithic structures may be used during the step of assembly which precedes the pouring the modular according to the desired size of the panel, the combination of which monolithic structures facilitates the positioning of all the translucent material elements needed to make the panel in the formwork. This solution allows to further reduce manufacturing costs. Furthermore, the positioning of such modular structures does not require qualified, specialized personnel and is also suitable for possible process automation.

### LIST OF FIGURES

Further features and advantages will be apparent from the following detailed description of the manufacturing method of the cementitious article according to the present invention illustrated by way of non-limitative example by means of the accompanying drawings:

FIG. 1 is a perspective view of a cementitious mortar based composite panel according to the present invention;

FIGS. 2 and 3 are perspective views from different points of view of a structure made of light translucent material which can be used in the method according to the present invention;

FIGS. 4 and 5 are a plan view and a side view of the structure shown in FIGS. 2 and 3, respectively;

FIGS. 6 and 7 are an exploded view and a plan view related to a step of the method according to the present invention, respectively;

FIG. 8 shows a further step of the method according to the invention;

FIG. 9 shows a first possible combination of structures made of translucent material which can be used in the method according to the present invention;

FIG. 10 shows a second possible combination of structures made of translucent material which can be used in the method according to the present invention;

FIG. 11 shows a third possible combination of structures made of translucent material which can be used in the method according to the present invention;

FIGS. 12 and 13 are views related to a step of the method according to the present invention in a possible embodiment;

FIGS. 14 and 15 are plan views related of a step of the method according to the present invention in a possible embodiment;

FIGS. 16 and 17 are an exploded view and side view, respectively, related to a step of the method according to the present invention in a further possible embodiment.

The same reference numbers and letters in the figures refer to the same elements or components.

### DETAILED DESCRIPTION

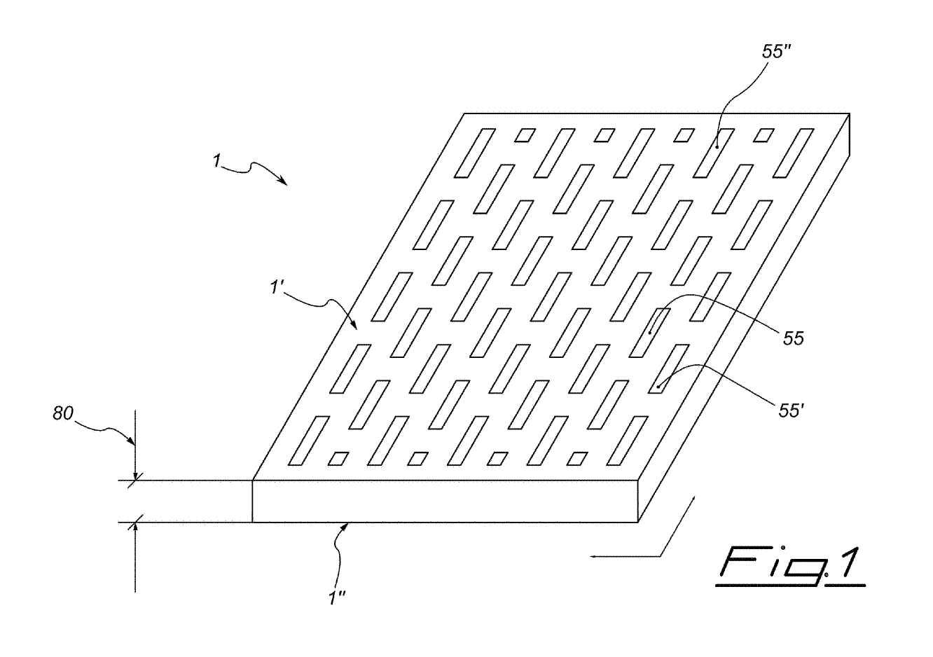

The present invention thus relates to a method for making a cementitious mortar based composite panel comprising a plurality of elements 55, 55′, 55″ made of light translucent material which allows the light transmission through the panel 1 from one first flat side 1′ to a second flat side 1″ of the panel itself. FIG. 1 is a perspective view of a panel 1 which can be made according to the present invention in which the flat sides 1′,1″, which are the main sides of the panel 1, i.e. those with a greater extension, are indicated. For the purposes of the invention, the distance between the first side 1′ and the second side 1″ defines the thickness of the panel 1 (indicated by reference numeral 80), such a distance being evaluated according to a direction substantially orthogonal to parallel planes on which the two main sides 1′,1″ are developed.

The method according to the present invention includes making a monolithic structure 3 of light translucent material adapted to be incorporated, following the pouring of cementitious mortar and subsequent hardening thereof, in a cementitious article. The latter will be then finished/squared off so as to define the panel 1, and in particular its flat sides 1,1′ indicated above. For the purposes of the present invention, the expression “monolithic structure” means a structure made in one piece by means of a plastic injection molding process of light translucent material, such as, for example the PMMA typically used for this type of applications.

As specified in greater detail below, the structure 3 in addition to being “monolithic” is preferably modular to allow the combination with other monolithic structures 3′,33,33′,66,66′,99,99′, which are functionality and constructively equivalent, as will be described in greater detail with regards to FIGS. from 9 to 11. Such a modular combination allows to make panels of different size without needing to change the size of the monolithic structure of translucent material for this purpose. In other words, varying the size of the panel implies varying the number of monolithic structures used, but not varying the size of the structures themselves, which may be advantageously made in series.

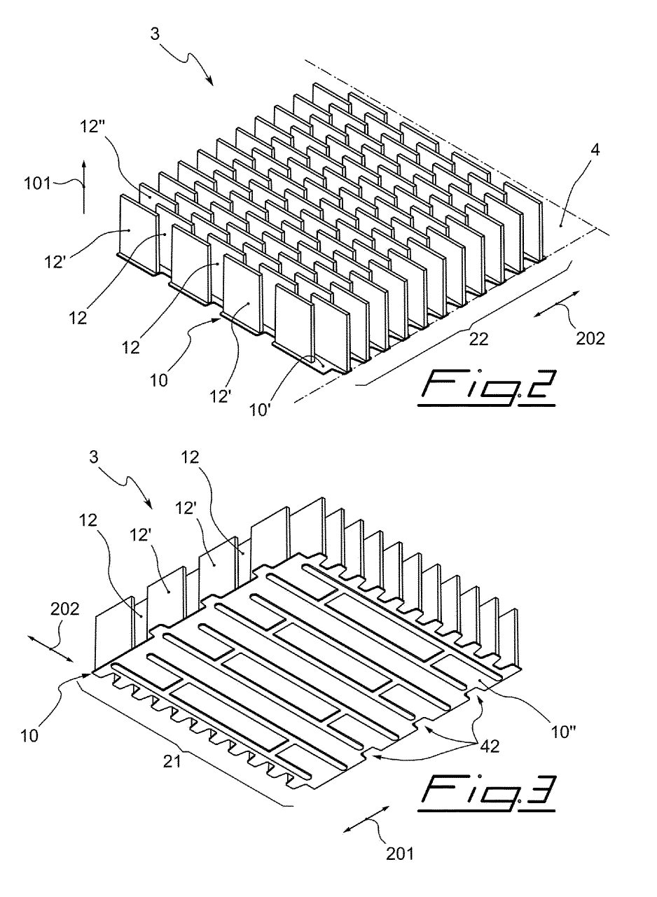

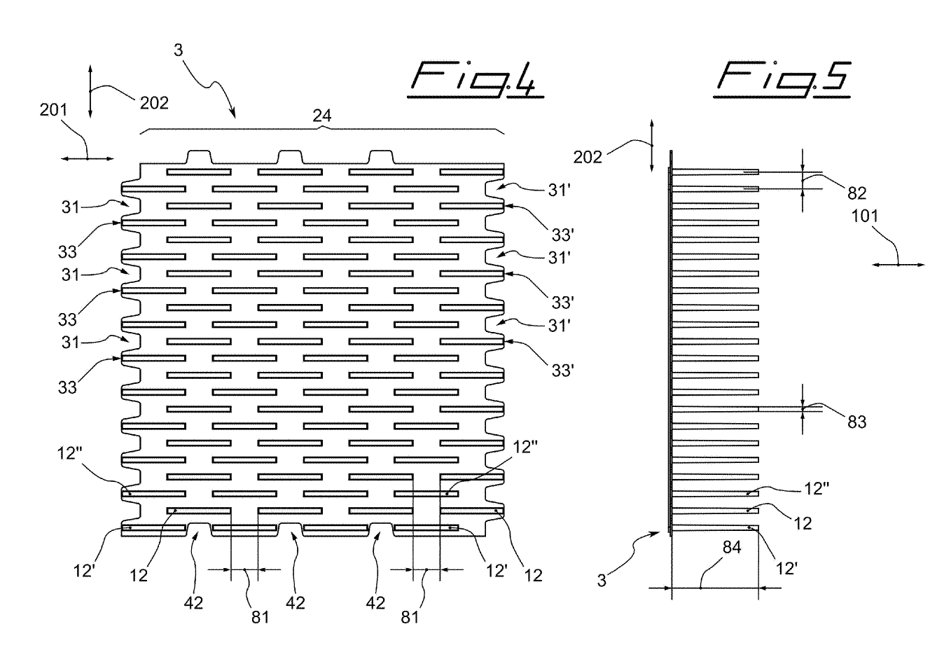

FIGS. 2 and 3 are perspective views of a possible embodiment of a structure 3 which can be used in the method according to the present invention. Such a structure comprises a base surface 10 (hereinafter also indicated as “base 10”) and a plurality of elements 12,12′,12″. The base 10 is developed substantially on a reference plane 4, while the elements 12, 12′, 12″ are developed on a same side (first side 10′) of the base 10 according to a direction of development 101 which is substantially orthogonal to the base 10 itself (i.e. to said reference plane 4). As mentioned above, such elements 12, 12′, 12″ are made in one piece with the base surface 10 by means of a plastic injection process. FIG. 3 shows one side 10″ of the base surface, opposite to the first side from which the elements 12,12′,12″ develop, in which the injection channels 15 of the plastic material typical of the injection process are highlighted.

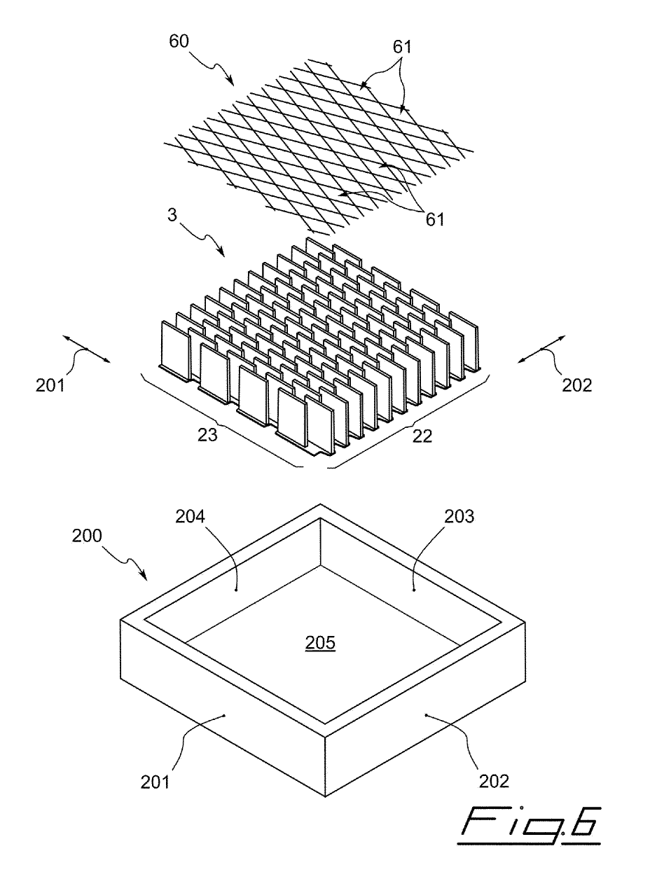

The plan view in FIG. 4 shows a preferred arrangement of the elements 12, 12′, 12″, which are arranged according to parallel lines in which each element is separated from the other elements adjacent thereto. Hereafter, the direction in which such files are developed is indicated as “longitudinal direction” 201, while “crosswise direction” 202 means a direction orthogonal to the longitudinal direction 201. The elements of each row are indicated by the same reference numeral. Furthermore, the elements of each row are arranged at regular intervals along the longitudinal direction 201, i.e. are separated by a predetermined separation space. The extension of such a space is shown in FIG. 4 by distance 81 measured along the development direction 201 of the row itself. It is also worth observing that the row of elements 12, 12′,12″ are equally distanced along a crosswise direction 202 orthogonal to the longitudinal direction 201 in which the rows themselves are developed. The distance between two adjacent rows is indicated by reference numeral 82 in the side view in FIG. 5.

Again with reference to FIGS. 4 and 5, the elements 12, 12′, 12″ preferably have a substantially rectangular cross-section taken along a section plane substantially parallel to the reference plane 4 on which the base 10 is developed. The thickness of the elements (indicated by reference numeral 83 in FIG. 5) is preferably the same for all elements 12,12′,12″. The height of such elements (measured along direction 101 and indicated by reference numeral 84 in FIG. 5) is established as a function of the thickness 80 established for the panel 1 which it is intended to obtain. With this regard, since the through portions 55,55′,55″ of the panel 1 have a height corresponding to such a thickness 80 of the panel 1, it results that the height 84 of the elements 12,12′,12″ of the structure must be either greater than or equal to that of the thickness 80 of the panel 1. Indeed, according to the invention, each through portion 55,55′,55″ of the panel 1 corresponds to a portion of a corresponding element 12,12′,12″ of the monolithic structure 3.

According to a preferred arrangement, shown in the figures, the elements 12 of each row are arranged in longitudinally offset position with respect to the elements 12′,12″ of the adjacent rows. In particular, each element of a first row of elements (indicated by reference numeral 12) faces a corresponding separation space defined between two elements of a second row of elements (indicated by reference numeral 12′) on a first side and a corresponding separation space defined between two elements of a third row of elements (indicated by reference numeral 12″) on a second side. Consequently, the elements 12′ of the second row and the elements 12″ of the third row are symmetric with respect to the first row of elements 12′.

It is understood that the foregoing offset arrangement is to be understood as preferred and is thus not binding. Consequently, the elements 12, 12′, 12″ of the structure 3 could have a different arrangement. Similarly, the cross-section of the elements 12,12′,12″ could also be different from the rectangular shape indicated above as preferred embodiment.

As mentioned above, in order to increase the versatility of the method for making the panels, the monolithic structure 3 is modular by virtue of the presence of reference means for the modular coupling of the structure itself with a second equivalent structure. With reference to FIGS. from 2, 3, 4 and 6, the base 10 of the structure 3 preferably defines a perimeter comprising a first crosswise peripheral portion 21 and a second crosswise peripheral portion 22, which also extend according to the crosswise direction 202. Such crosswise portions 21, 22 each define a “reference toothing” comprising recesses 31,31′ alternating with protrusions 33,33′. More specifically, the first crosswise peripheral portion 21 defines a first reference toothing, while the second crosswise peripheral portion 22 defines a second reference toothing. For example, FIG. 4 shows that the first reference toothing is defined so that each recess 31 and each protrusion 33 are aligned longitudinally with a corresponding protrusion 33′ and with a corresponding recess 31′ of the second reference toothing. As shown in FIG. 4, according to the invention, the shape of the protrusions 33,33′ and the recesses 31,31′ geometrically mate so that, as a whole, the first crosswise peripheral portion 21 geometrically mates with the second crosswise peripheral portion 22 to allow the modular combination of two monolithic structures. This means that the first reference toothing of a first monolithic structure 3 may advantageously engage the second reference toothing of another monolithic structure (for example, see the modular combination in FIG. 10 or 11). In the illustrated case shown, the protrusions 33,33′ and the recesses 31,31′ have a substantially trapezoidal shape. The perimeter of the base preferably also comprises a first longitudinal portion 23 and a second longitudinal portion 24 (indicated in FIGS. 4 and 6) which extend parallel to the rows of elements 12,12′,12″ comprising, a first series of reference elements and a second series of reference elements, respectively. In a preferred embodiment, the first longitudinal portion 23 (indicated in FIG. 6) comprises a series of recesses 42 (indicated in FIGS. 3 and 4), each of which is substantially defined at a separation space between two elements 12′ of the row closest to the first longitudinal portion 23 itself. Instead, the second longitudinal portion 24 (indicated in FIG. 4) comprises a series of protruding portions 43, or protrusions 43, each of which develops outwards. Each protruding portion 43 is defined so as to be aligned, along the crosswise direction 202, with a corresponding recess 42 of the first longitudinal portion 23. With this regard, the shape of each protruding portion 43 geometrically mates with the shape of the corresponding recess 42 with which it is transversely aligned. The shape of each protrusion 43 is such to be able to engage a corresponding recess 42 so as to allow a modular combination of two structures as shown in FIG. 9, for example. Preferably but not exclusively, the protruding portions 43 and the recesses 42 of the respective longitudinal portions 23,24 have a trapezoidal shape.

With reference to the exploded view in FIG. 6, the method according to the invention includes providing a formwork 200 in which the monolithic structure 3 is housed. The size of the formwork 200 is characteristic of the final extension of the panel 1 which it is intended to obtain. For the purposes of the present invention, the word “formwork” generically indicates a containing element comprising a bottom 205 and walls 201,202,203,204, which are developed from the bottom 205 defining an upper opening through which a monolithic structure 3 can be inserted and then the cementitious mortar can be poured.

In the embodiment shown in FIG. 6, the formwork 200 is sized so as to contain a single monolithic structure 3, the base 10 of which has a substantially “square” shape, this meaning that the extension of the longitudinal portions 21,22 is substantially equivalent to crosswise portions. Consequently, also the formwork 200 has a substantially square structure. This means that the monolithic structure 3 could also have a different configuration. The longitudinal extension of the base 10 may be greater than the crosswise extension, or vice versa, according to a typically rectangular conformation.

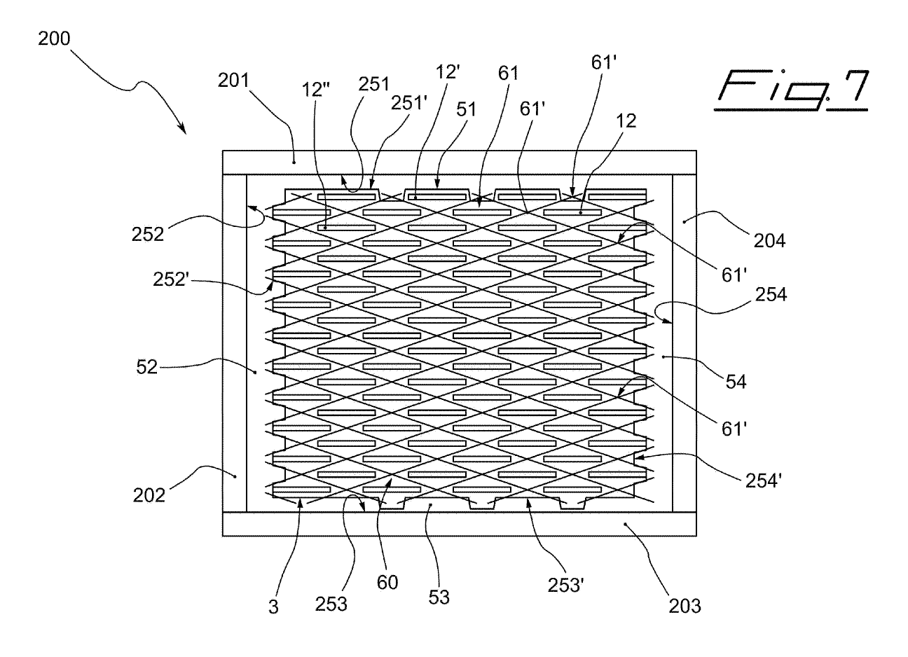

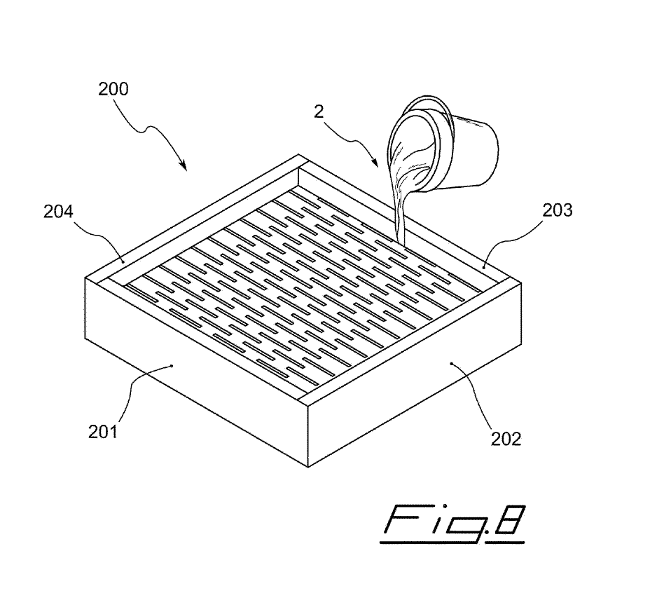

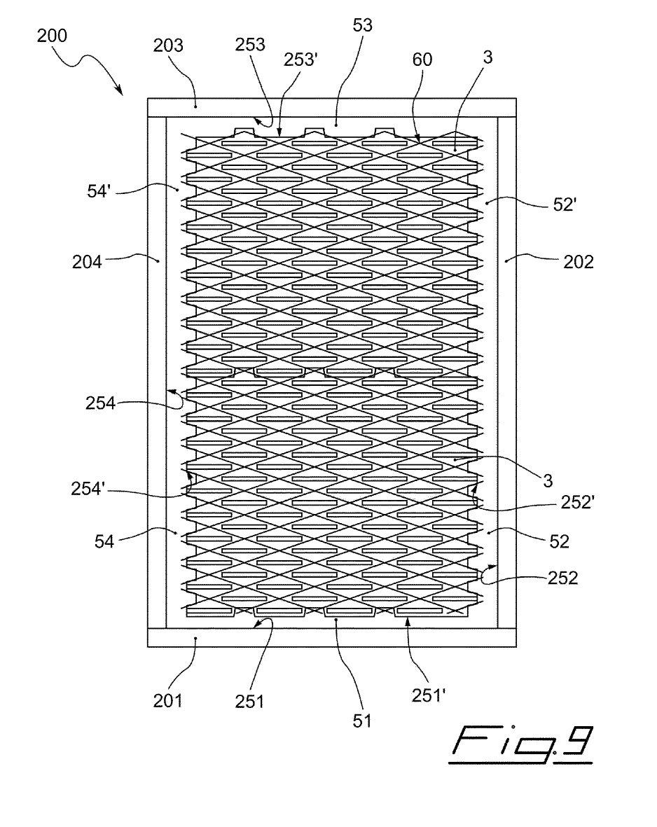

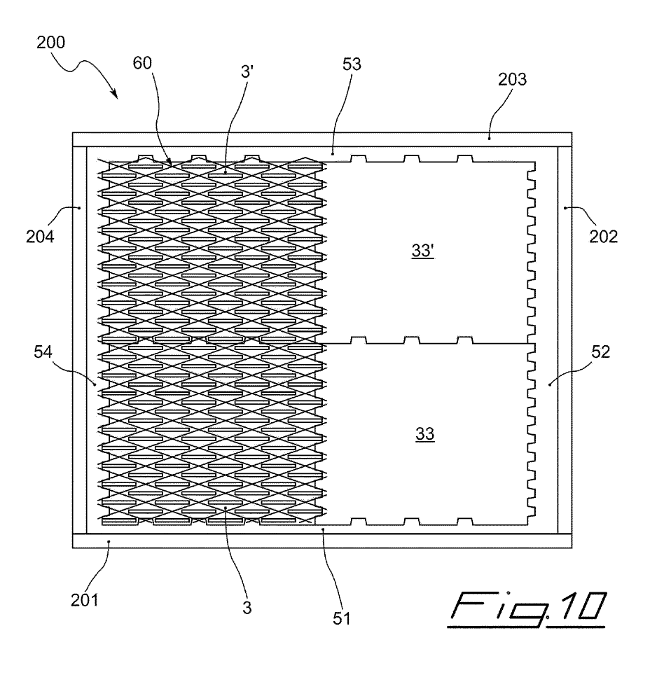

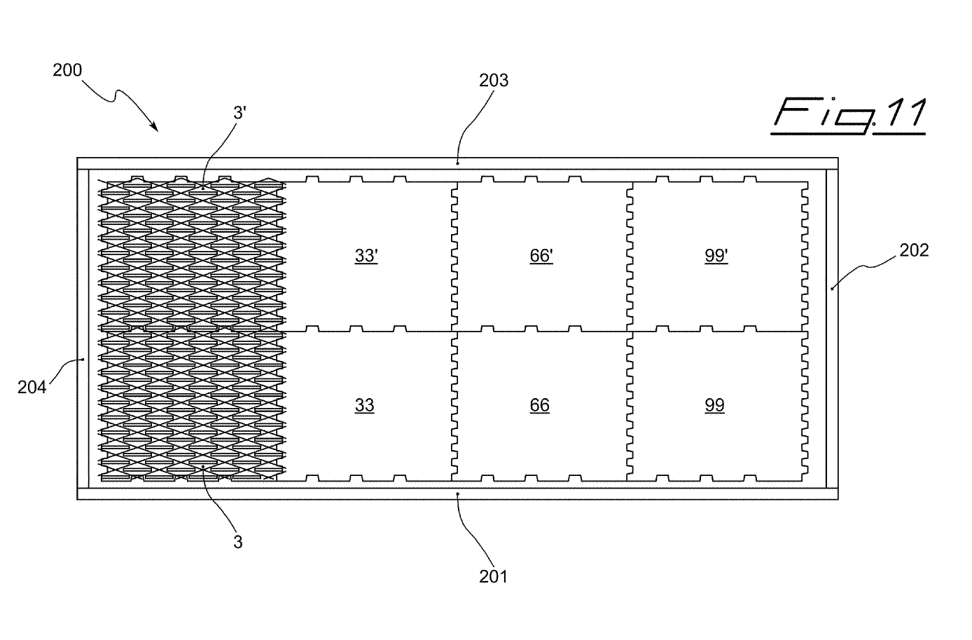

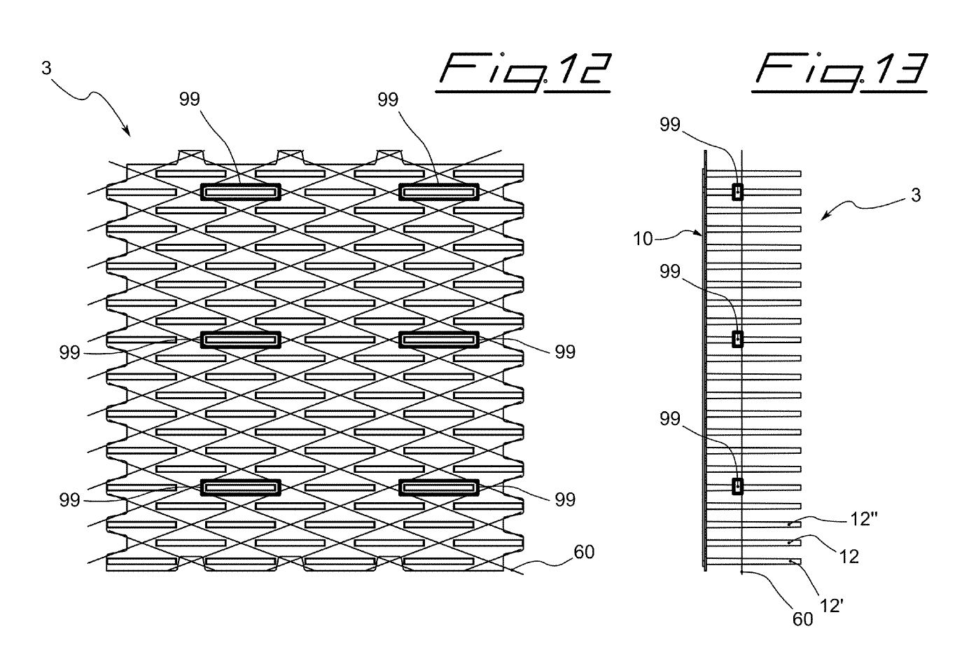

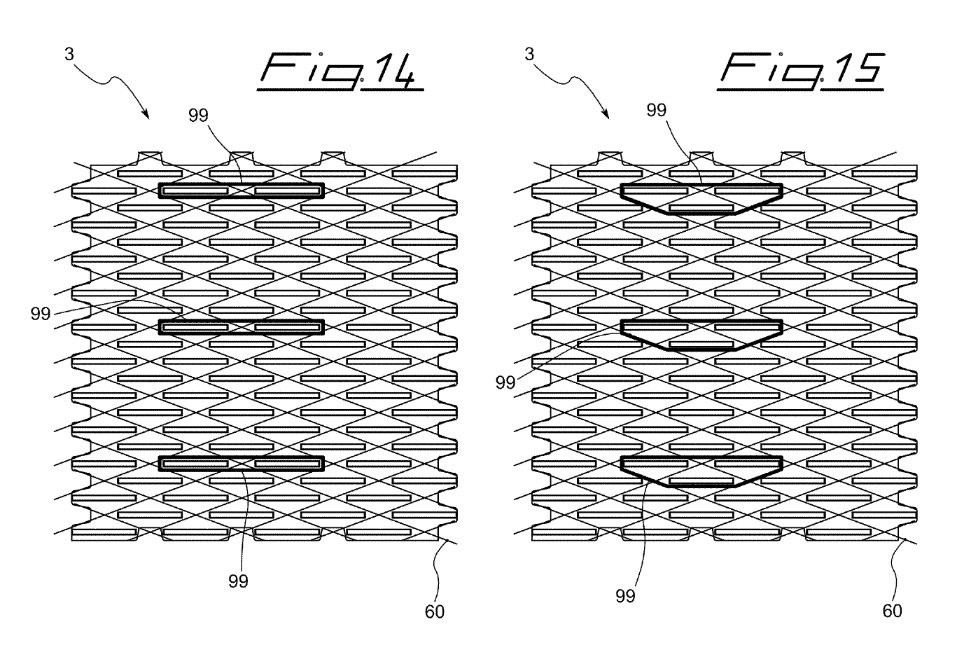

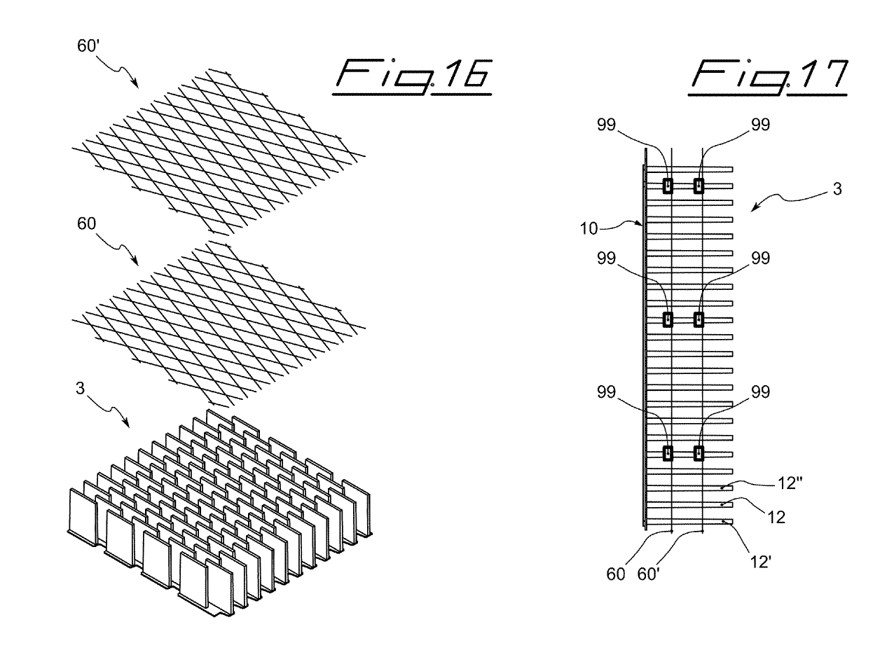

With reference to FIGS. 6 and 7, the method according to the invention thus includes housing at least one monolithic structure 3 in the formwork 200 so that the base 10 of the structure rests on the bottom 205, i.e. so that the upper opening of the formwork 200 remains free. According to a preferred embodiment, shown in the figures, the method includes arranging at least one metallic grid 60 in the formwork 200. In particular, such a grid 60 is arranged between the elements 12,12′,12″ of the structure 3 so that each mesh 61 surrounds at least one element 12,12′,12″.

If the elements 12, 12′,12″ are arranged in “offset” rows as shown in the figures, the grid 60 may advantageously have rhomboid shaped meshes 61 each of which indeed surrounds at least one element 12,12′,12″ of the structure 3. In a possible embodiment (not shown), the width of the meshes 61 of the grid could be such to surround an assembly of elements 12, 12′, 12″ of the structure 3. FIG. 7 is a plan view which shows the structure 3 and the metallic grid 60 inside the formwork 200. It is worth noting that in the embodiment shown, each vertex 61′ of each rhomboid mesh 61 is arranged substantially in a corresponding separation space between two elements 12,12′,12″ of the same row. Each mesh 61 of the grid 60 in FIG. 7 surrounds one of the elements 12,12′,12″. The size of the meshes 61 is thus chosen according to the size of the elements 12,12′,12″ of the structure 3 and the distance between the elements themselves. It is worth noting that the use of a grid 60 with rhomboid meshes 61 is very advantageous because it can be easily procured on the market at relatively low costs. Furthermore, the grid 60 is simply positioned by “fitting” it from the top without needing to “adjust” the grid itself (e.g. without the need for cutting segments or eliminating the vertexes of the meshes of the grid). With this regard, the rhomboid mesh grid 60 may be advantageously be obtained by means of a stretching process.

According to a preferred embodiment, the grid 60 is arranged at a predetermined height from the base 10 of the structure 3 preferably by using suspension means which keep the grid 60 suspended with respect to the base 10′ of the structure 3 while pouring the cementitious mortar. In this manner, the grid 60 will be incorporated in an intermediate portion 1′,1″ of the panel which will be obtained at the end of the method of manufacturing. FIGS. from 12 to 15 show a possible embodiment of such suspension means which appear in the form of suspension rings 99 (preferably but not exclusively made of deformable plastic material, e.g. rubber) which surround one or more elements 12, 12′, 12″ of the structure 3 at a predetermined height. With this regard, if the rings 99 surround one single element (FIGS. 12 and 13), the section of the rings 99 which will be chosen as a function of the longitudinal distance between two elements 12, 12′, 12″ so as to guarantee a resting surface for the stretches which form the meshes 61 of the grid 60. If the rings 99 surround an assembly of elements 12,12′,12″ (e.g. as shown in the examples in FIGS. 14 and 15), then the suspension function is achieved by effect of the extension of the rings 99 in the separation space between the elements of the assembly itself.

The suspension means described above as other possible functionally equivalent, may be positioned so that the grid 60 remains raised with respect to the base 10 by a predetermined value, e.g. ⅓ or ⅔ of the height 84 of the elements 12′,12′,12″. It is however in the scope of the present invention the possibility of arranging the grid 60 at a different height, in all cases sufficient to guarantee that the grid 60 and the suspension means remain distanced from the base 10 in order to prevent them from remaining visible at the end of the manufacturing of the panel.

Preferably, the suspension means of the grid are arranged only in some predetermined positions of the structure 3 sufficient to keep the grid 60 raised. In the examples shown in FIGS. from 12 to 15, suspension rings 99 are each arranged in position close to one of the four angles of the structure 3. The number and position of the rings 99 may be advantageously varied according to the extension of the structure 3.

Furthermore, it is included in the present invention the possibility of arranging a plurality of metallic grids 60,60′ in the formwork 200 above all when manufacturing thick panels. This solution allows to increase the strength of the panel itself. With this regard, FIG. 16 diagrammatically shows a monolithic structure 3 to which two metallic grids 60,60′ are associated supported by corresponding suspension rings 99,99′ arranged at different heights.

This means that if the elements of the structure 3 have an arrangement different from the offset arrangement shown in the figures, then the shape of the grid or grids used may be different from the rhomboid shape shown in the figures. If the elements of the structure 3 are aligned in all directions (i.e. are aligned longitudinally and crosswise) a square or rectangular mesh grid may be used, for example.

In order to facilitate the positioning and the centering of the monolithic structure 3 in the formwork 200, in a preferred embodiment, the method includes arranging reference profiles shaped in manner geometrically corresponding to the peripheral portions 21,22,23,24 of the base 10 of the structure 3 on the bottom of the formwork 200. In the example in FIG. 7, reference profiles 51,52,53,54 which define an inner frame as a whole are provided. For example, such profiles 51,52,53,54 may be made of a low-cost plastic material. Each of these profiles comprises a substantially flat outer side 251,252,253,254 adapted to rest against a corresponding inner peripheral portion of the formwork 200. Each profile 51,52,53,54 further comprises an inner side 251′,252′,253′,254′ shaped to geometrically mate with one of the peripheral portions 21,22,23,24 of the base 10 of the structure 3. In the embodiment shown in FIG. 7, a first inner side 251′ of a first profile 51 and a second inner side 253′ of a second profile 53, reciprocally opposite and geometrically mating with the crosswise peripheral portions 21,22 of the base 10 of the structure 3, and a third inner side 252′ of a third profile 52 and a fourth inner side 254′ of a fourth portion 54, reciprocally opposite and geometrically mating with the longitudinal portions 23,24 of the base 10 itself are thus identified.

Indeed, the use of reference profiles 51,52,53,54 allows an easy positioning of the structure 3 and its correct positioning during the subsequent pouring. In other words, the reference profiles 51,52,53,54 allow to arrange and keep the monolithic structure 3 in a predetermined position inside the formwork 200 also facilitating in this manner the subsequent steps of finishing off of the cementitious mortar 2 obtained after the pouring and hardening of the cementitious mortar. In all cases, it is understood that the monolithic structure 3 could be arranged in the formwork 200 regardless of the presence of such reference profiles 51,52,53,54.

With this regard, FIG. 8 refers precisely to this step in which the mortar is poured vertically between the elements 12,12′,12″ of the structure 3, i.e. according to a pouring direction which is orthogonal to the development direction of the elements themselves. As the bottom 205 is substantially horizontal during pouring, the step of pouring is very fast and the cementitious mortar is easily distributed between the elements of the structure itself. For the purposes of the present invention, all the cements described in UNI-EN 197.1 may be used. In particular, it is preferably to use type I cements in class 52.R. The cementitious mortar is preferably poured to be substantially “flush” with the upper edge 203 of the formwork 200. It is worth noting that the use of a monolithic structure 3 as shown above is particularly advantageous because contrarily to the traditional methods, the cementitious mortar may be poured without any counterindications from any side of the formwork 200 and/or from any position over the formwork.

Following the step of hardening of the cementitious mortar, a cementitious mortar is thus obtained in which the elements 12,12′,12″ of the monolithic structure 3 and the grid 60, if present, arranged between the elements themselves are incorporated. The base 10 of the monolithic structure 3 is substantially arranged on a side of the cementitious article corresponding substantially to the formwork 200. At this point, the method according to the invention includes finishing off the cementitious article by eliminating the base 10 of the structure 3 so that only portions of the elements 12,12′,12″ of the structure itself are incorporated. Such portions correspond to the portions 55,55′,55″ of the panel 1 according to the objects of the method of the present invention.

From the above it is apparent that with respect to traditional methods, the method according to the invention allows a considerable reduction of manufacturing time because the elements 12,12′,12″ made of light translucent materials are all arranged in the formwork 200 in a single operation, which corresponds to the positioning of the monolithic structure 3.

FIGS. from 9 to 11 show further peculiarities of the method according to the invention related to the modularity features which characterize the monolithic structure 3. FIG. 9 is a plan view of a rectangular formwork 200 the size of which is such to house two structures 3,3′ of shape similar to that shown in FIGS. 2 and 3. Also in this case, reference profiles 51,52,53,54, the outer sides 251, 252, 253, 254 of which adhere/rest on a corresponding inner wall of the formwork 200, may be preventively arranged in the formwork 200. The shape of the inner side 251′,252′,253′,254′ of each profile geometrically mates with a corresponding peripheral portion 21,22,23,24 of the base 10 of the structures 3,3′ intended to be inserted in the formwork itself. In the situation shown in FIG. 9, it is worth noting that at least one peripheral portion of each structure 3,3′ is combined with a corresponding peripheral portion of the other structure. At the same time, the other peripheral portions of each structure 3,3′ geometrically combine with the inner sides 251′,252′,253′,254′ of the reference profiles arranged previously in the formwork 200. This translates into an accurate, stable positioning of the structures 3,3′ during the step of pouring the cementitious mortar.

As shown in FIG. 8, the grid 60 may be easily cut “to size” for the formwork 200, and once fitted on the two structures 3,3′ it contributes to keeping them in a stable position during pouring. It is worth noting that following the extraction of the cementitious article, the reference profiles may be advantageously reused. It is also possible to provide a disposable method for these profiles which in all cases may be easily available at low cost.

FIG. 9 also shows that the reference profiles may be advantageously modular. In the case of a rectangular formwork 200 like the one shown in FIG. 9, two reference profiles 52,52′, 54, 54′ having the same shape geometrically mating with a corresponding peripheral portion of the monolithic structures 3,3′ may be provided along each side of greater extension 202,204. In other words, the modularity of the reference profiles follows the principle of modularity of the monolithic structures 3,3′.

FIG. 10 shows another possible embodiment which includes a modular combination of four structures, only two of which 3,3′ are illustrated for the sake of better clarity, in the substantially square formwork 200. Of the other two structures (indicated by reference numerals 33,33′) only the perimeter of the respective base 10 is shown in FIG. 10. Similarly, the grid 60 is only shown for the two structures 3,3′, but it is understood that it also extends to the other structures 33,33′ intended for housing in the formwork 200. It is worth nothing that in the situation shown in FIG. 10, each structure comprises two peripheral portions each geometrically coupled/engaged by a peripheral portion of an adjacent structure. Furthermore, for each structure 3,3′,33,33′ the other peripheral portions are coupled/engaged by a corresponding reference profile 51,52,53,54. The considerations illustrated above with regards to the modularity of the reference profiles applies also to the situation in FIG. 10. It is apparent that also in the situation in FIG. 10, the presence of reference means facilitates the modular combination of the structures 3,3′,33,33′ thus avoiding the need for specialized or qualified personnel for these operations. It is worth noting that the positioning of the monolithic structures and possibly of the grid or metallic grids could also be easily automated with further reduction of overall costs.

FIG. 11 shows a further a possible embodiment of the method according to the invention, in which the size of the rectangular shaped formwork 200 is such to house a modular combination of eight monolithic structures 3,33,3′,33′,66,66′,99,99′ similar to those shown in FIGS. 2 and 3. For the sake of simplicity, FIG. 11 also shows only two structures 3,3′, while for the others (indicated with reference numerals 33,33′,66,66′,99,99′) only the perimeter of the base 10 is indicated for the purpose of highlighting the modularity of the assembly of the structures themselves in the formwork 200.

In the examples shown in FIGS. from 9 to 11, it is apparent that the advantage of using modular structures 3,33,33′,66,66′,99,99′ for creating cementitious mortar based composite panels. According to the desired size of the panel, it will be sufficient to arrange a formwork 200 of corresponding size and one or more monolithic structures (having equivalent shape and size) which will be combined/positioned inside the formwork 200 in extremely rapid manner by exploiting the various reference means (crosswise and longitudinal reference means) defined on the peripheral portions 21,22,23,24 of the structures and possible the reference profiles preventively arranged inside the formwork 200. The fact of using a plurality of monolithic structures 3,33,33′,66,66′,99,99′ which can be obtained by means of the same plastic injection process is a considerable advantage in terms of functional versatility. Substantially, the need to vary the size of the panel for production reasons does not impact on the manufacturing process of the monolithic structures. This implies a considerable reduction of manufacturing costs. As described above, the modularity principle may be advantageously applied also to possibly making and using reference profiles for positioning the monolithic structures inside the formwork.

It is further worth noting that the modularity expressed above is particularly advantageous because it allows to obtain panels with different optical translucency effects. Indeed, monolithic structures 3,33,33′,66,66′,99,99 could be made with translucent materials having different color. The subsequent modular combination of such structures could thus allow to make panels having translucent zones with different colors.

The method according to the invention allows to fully fulfill the predetermined tasks and objects. In particular, the method allows to considerably reduce manufacturing making the desired panels usable at costs extremely lower than the methods currently used for the same purpose. Furthermore, the method according to the invention is very versatile because it allows to easily differentiate panel manufacturing in terms of size.

1. A method for making a cementitious mortar based composite panel provided with through portions made of translucent material for light transmission from one first side to a second side of the panel opposite to said first side, said method comprising the steps of:
preparing a formwork for pouring the mortar;
preparing a structure of said light translucent material, said structure comprising a base and a plurality of elements made in one piece with said base, said elements developing on the same side of said base surface;
positioning said translucent material structure within said formwork;
pouring mortar into said formwork so that said mortar is distributed between said elements of said structure and so as to generate a substantially prism-shaped semi-finished mortar product after the hardening of said mortar in which said elements of said structure are incorporated;
extracting said semi-finished product from said formwork after the hardening of said mortar;
finishing off said semi-finished product so that said through portions of said panel are defined by corresponding portions of said elements of said structure.

2. The method according to claim 1, wherein said semi-finished product is finished off by eliminating said base from said structure.

3. The method according to claim 1, wherein after positioning said structure in said formwork, said method comprises the step of providing at least one reinforcing grid between said elements of said structure so that each mesh of said grid surrounds at least one of said elements of said structure.

4. The method according to claim 3, wherein said method comprises the step of providing at least one grid through suspension means which maintain the grid suspended at a predetermined height with respect to the base of the structure during the pouring of said mortar.

5. The method according to claim 1, wherein said elements of said structure develop according to a direction of development which is substantially orthogonal to said base having a substantially rectangular cross-section, said cross-section being evaluated according to a plane substantially orthogonal to said direction of development.

6. The method according to claim 1, wherein said elements of said structure are arranged in parallel rows, wherein each element of each row is distanced from the adjacent elements of the same row, and wherein the elements of each row are offset with respect to the elements of the adjacent rows.

7. he method according to claim 3, wherein said grid comprises rhomboid meshes.

8. The method according to claim 1, wherein said structure is made by means of a plastic injection molding process of light translucent material.

9. The method according to claim 1, wherein said method includes configuring peripheral portions of said base of said structure so as to define reference means for coupling said structure to at least one other structure made of light translucent material.

10. The method according to claim 1, wherein said method includes providing reference profiles for the positioning of said translucent material structure within said formwork, each profile comprising one side configured in manner geometrically conforming to a peripheral position of said base of said structure.

11. A structure made of light translucent material for making a mortar-based composite panel by means of a method according to claim 1, characterized in that it comprises a base and a plurality of elements made in one piece with said base by means of a plastic injection molding process, said elements developing on a same side of said base according to a direction of development substantially orthogonal to said base, said base comprising reference means configured to obtain the modular coupling of said structure with at least one other structure made of light translucent material.

12. The structure according to claim 11, wherein said elements are arranged at regular intervals in rows parallel to a longitudinal direction, wherein each element of each of said rows is distanced from the elements adjacent thereto, and wherein the elements of each row are offset with respect to the elements of the adjacent rows.

13. The structure according to claim 12, wherein a first side of each element of a first row of elements faces a separation space between two elements of a second row of elements, and wherein a second side of each element of said first row of elements faces a separation space between two elements of a third row of elements opposite to said second row of elements, said third row of elements being symmetric to said second row of elements with respect to said first row of elements.

14. The structure according to claim 10, wherein said reference means comprise a first reference toothing defined by a first crosswise peripheral portion of said base and a second toothing defined by a second crosswise peripheral portion of said base.

15. The structure according to claim 14, wherein said first reference toothing and said second reference toothing comprise recesses alternating with protrusions, and wherein each recess/protrusion of said first reference toothing is aligned with a corresponding protrusion/recess of said second toothing.

16. The structure according to claim 11, wherein said reference means comprise a first series of reference elements and a second series of reference elements defined by a first longitudinal peripheral portion and by a second longitudinal peripheral portion of said base of said structure, respectively.

17. The structure according to claim 16, wherein said first series of reference elements comprises a series of recesses defined along said first longitudinal peripheral portion, and wherein said second series of reference elements comprise a series of protrusions defined along said second longitudinal peripheral portion, wherein each recess is aligned with a corresponding protrusion.

18. The mortar-based panel obtained by means of a method according to claim 1.
